(19) United States
(12) Patent Application Publication
(10) Pub. No.: US 2016/0285929 A1
(43) Pub. Date: Sep. 29, 2016

(54) FACILITATING DYNAMIC AND SEAMLESS TRANSITIONING INTO ONLINE MEETINGS

(71) Applicant: INTEL CORPORATION, Santa Clara, CA (US)

(72) Inventors: ALEXANDER A. OGANEZOV, Portland, OR (US); SHAMIM BEGUM, Beaverton, OR (US)

(73) Assignee: INTEL CORPORATION, Santa Clara, CA (US)

(21) Appl. No.: 14/671,225

(22) Filed: Mar. 27, 2015

(51) Int. Cl. H04L 29/06; H04L 12/18

(52) U.S. Cl. CPC H04L 65/403; H04L 12/1831

(57) ABSTRACT

A mechanism is described for facilitating dynamic and seamless transitioning into online meetings at computing devices according to one embodiment. A method of embodiments, as described herein, includes receiving a request from a participant of a plurality of participants of an online meeting, where the request indicates disengagement of the participant from the meeting. The method may further include initiating recording of proceedings of the online meeting during absence of the participant, where the proceedings include conversations of remaining participants of the plurality of participants during the absence of the participant. The method may further include intelligently formatting the recording, where the replaying engine is further to replay the formatted recording to the participant while transitioning the participant back into the online meeting.

### FIELD

Embodiments described herein generally relate to computers. More particularly, embodiments relate to facilitating dynamic and seamless transitioning into online meetings.

### BACKGROUND

Online meetings are common and well-known. However, each time a participant has to step away from the meeting, even for a brief amount of time, the participant misses out on that portion of the meeting. Conventional techniques do not provide for the participant to catch up on the conversation that typically gets too far away from the point of disengagement to the point of return.

### BRIEF DESCRIPTION OF THE DRAWINGS

Embodiments are illustrated by way of example, and not by way of limitation, in the figures of the accompanying drawings in which like reference numerals refer to similar elements.

FIG. 1 illustrates a computing device employing a seamless online meeting transitioning mechanism according to one embodiment.

FIG. 2 illustrates a seamless online meeting transitioning mechanism according to one embodiment.

FIG. 3A illustrates a transaction sequence for recording, processing, and broadcasting of speech data as facilitated by a seamless online meeting transitioning mechanism of FIGS. 1-2 according to one embodiment.

FIG. 3B illustrate a transaction sequence for selection and filtering out of recording tracks as facilitated by a seamless online meeting transitioning mechanism of FIGS. 1-2 according to one embodiment.

FIG. 3C illustrates a screen shot of a transaction sequence of FIG. 3B as facilitated by a seamless online meeting transitioning mechanism of FIGS. 1-2 according to one embodiment.

FIG. 3D illustrates a transaction sequence of recording, replaying, and transitioning as facilitated by a seamless online meeting transitioning mechanism of FIGS. 1-2 according to one embodiment.

FIG. 3E illustrates a method for seamless transitioning into online meetings as facilitated by a seamless online meeting transitioning mechanism of FIGS. 1-2 according to one embodiment.

FIG. 4 illustrates computer system suitable for implementing embodiments of the present disclosure according to one embodiment.

FIG. 5 illustrates computer environment suitable for implementing embodiments of the present disclosure according to one embodiment.

### DETAILED DESCRIPTION

In the following description, numerous specific details are set forth. However, embodiments, as described herein, may be practiced without these specific details. In other instances, well-known circuits, structures and techniques have not been shown in details in order not to obscure the understanding of this description.

Embodiments provide for seamless recording and replaying of meetings where a participant may temporarily disengage from a live meeting and seamlessly transition back into the meeting upon return after some time. In one embodiment, recording and replaying of contents of a live meeting is performed such that any participant may choose to disengage and seamlessly return back to the meeting by simply reviewing the replay of a recorded version of the contents that were missed during the absence. In one embodiment, the recorded version may be intelligently shortened or made faster by performing one or more of (without limitation): 1) reducing the silent portions of the contents by percentage and/or time; 2) tailoring the contents based on each participant's speech pattern; and 3) generic fast-forwarding of the contents.

It is contemplated that “disengagement” from a live meeting is not limited to any manner of disengagement or any amount of time the user remains disengaged from the meeting. For example, “disengaging” may include a user “departing” a live meeting to run an errant or “leaving” the meeting to attend a phone call or go to the bathroom or simply “suspending” paying attention to the meeting or “muting” the meeting for a while or accidently “disconnecting” or “losing contact” or falling asleep or “losing interest” for some time, and/or the like, while the audio may still be coming through and therefore, such disengagements may range from a few seconds (such as when distracted or losing attention, etc.) to several minutes (such as when taking another phone call, taking off the headset, or going to the bathroom, etc.) to a number of hours (such as running an errand or keeping an appointment, etc.) to even days (such as missing an entire day or more in a multi-day conference, etc.), and/or the like. Accordingly, throughout this document, it is contemplated that “disengage” from a live meeting may include and/or be interchangeably referred to as “leave” a live meeting, “depart” from a live meeting, “suspend” listening to a meeting, “mute” a live meeting, “disconnect” from a live meeting, “lose contact” with a live meeting, “lose interest” in a live meeting”, and/or the like.

It is contemplated that individuals (also referred to as “users” or “participants”) may choose to participate in online meetings using any number and type of computing devices (also referred to as “participating devices”), such as desktop computers, laptop computers, tablet computers, smartphones, wearable devices (e.g., glasses, bracelets, smartcards, smartwatches, head-mounted devices, clothing items, etc.). Further, contents may be recorded and replayed using any number and type of forms and modalities, such as visual, auditory, haptic, olfactory, etc.

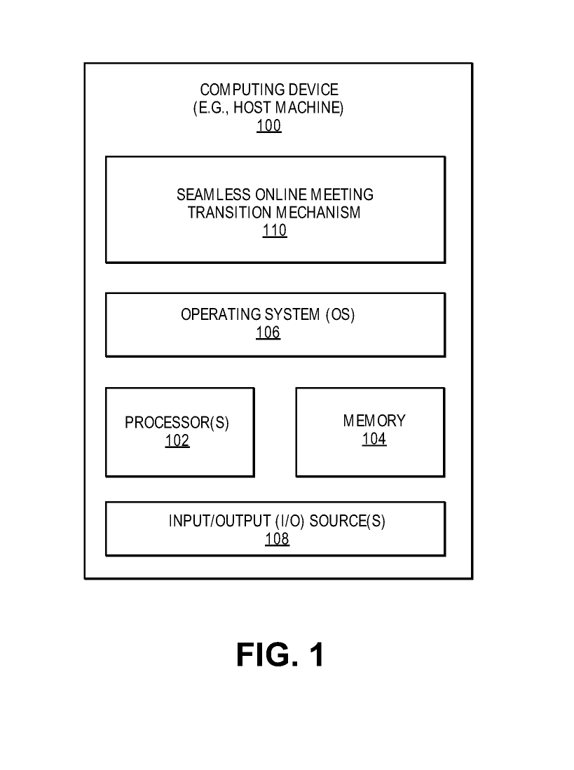

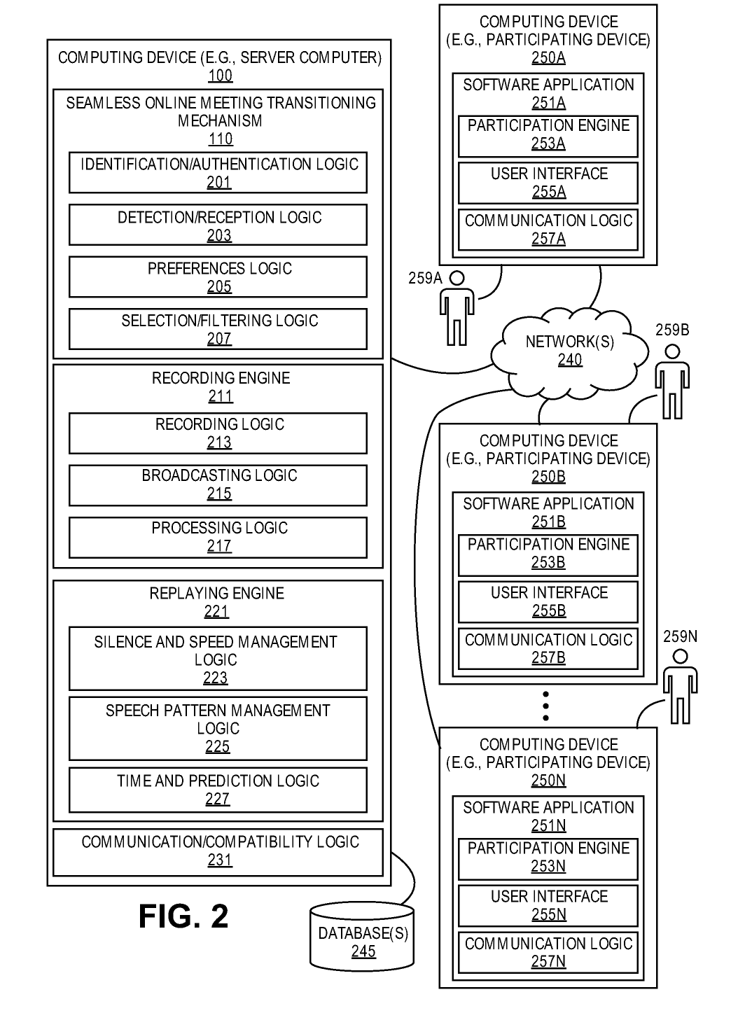

FIG. 1 illustrates a computing device 100 employing a seamless online meeting transitioning mechanism 110 according to one embodiment. Computing device 100 serves as a host machine for hosting online meeting transitioning mechanism (“seamless meeting mechanism”) 110 that includes any number and type of components, as illustrated in FIG. 2, to dynamically facilitate seamless transitioning of participants in and out of meetings as will be further described throughout this document.

Computing device 100 may include any number and type of data processing devices, such as large computing systems, such as server computers, desktop computers, etc., and may further include set-top boxes (e.g., Internet-based cable television set-top boxes, etc.), global positioning system (GPS)-based devices, etc. Computing device 100 may include mobile computing devices serving as communication devices, such as cellular phones including smartphones, personal digital assistants (PDAs), tablet computers, laptop computers (e.g., Ultrabook™ system, etc.), e-readers, media internet devices (MIDs), media players, smart televisions, television platforms, intelligent devices, computing dust, media players, head-mounted displays (HMDs) (e.g., wearable glasses, head-mounted binoculars, gaming displays, military headwear, etc.), and other wearable devices (e.g., smartwatches, bracelets, smartcards, jewelry, clothing items, etc.), and/or the like.

Computing device 100 may include an operating system (OS) 106 serving as an interface between hardware and/or physical resources of the computer device 100 and a user. Computing device 100 further includes one or more processors 102, memory devices 104, network devices, drivers, or the like, as well as input/output (I/O) sources 108, such as touchscreens, touch panels, touch pads, virtual or regular keyboards, virtual or regular mice, etc.

It is to be noted that terms like “node”, “computing node”, “server”, “server device”, “cloud computer”, “cloud server”, “cloud server computer”, “machine”, “host machine”, “device”, “computing device”, “computer”, “computing system”, and the like, may be used interchangeably throughout this document. It is to be further noted that terms like “application”, “software application”, “program”, “software program”, “package”, “software package”, “code”, “software code”, and the like, may be used interchangeably throughout this document. Also, terms like “job”, “input”, “request”, “message”, and the like, may be used interchangeably throughout this document. It is contemplated that the term “user” may refer to an individual or a group of individuals using or having access to computing device 100.

FIG. 2 illustrates a seamless online meeting transitioning mechanism 110 according to one embodiment. In one embodiment, seamless meeting mechanism 110 may include any number and type of components, such as (without limitation): identification/authentication logic 201; detection/reception logic 203; preferences logic 205; selection/filtering logic 207; recording engine 211 including recording logic 213, broadcasting logic 215, and processing logic 217; replaying engine 221 including silence and speed management logic 223, speech pattern management logic 225, and time and prediction logic 227; and communication/compatibility logic 231. Computing device 100 may further include I/O sources 108 of FIG. 1 having any number and type of capturing/sensing components (e.g., cameras, microphones, sensors, etc.) and output components (display devices/screens, speakers, etc.).

Computing device 100 may include a server computer serving as a host machine for employing seamless meeting mechanism 110 and may be in communication with any number and type of client computing devices, such as participating devices A 250A, B 250B, N 250N, over one or more networks, such as network(s) 240 (e.g., cloud network, the Internet, intranet, Internet of Things (“IoT”), proximity network, Bluetooth, etc.), where participating devices A 250A, B 250B and N 250N are capable of participating in online meetings on behalf of their users/participants 259A, 259B and 259N, respectively. Further, computing device 100 may be in communication with one or more repositories or databases, such as database(s) 245, where any amount and type of data (e.g., real-time data, historical contents, metadata, resources, policies, criteria, rules and regulations, upgrades, etc.) may be stored and maintained.

As aforementioned, participating devices 250A-250N may include any number and type of computing devices, such as desktop computers, mobile and wearable devices, such as (without limitation) smartphones, tablet computers, wearable glasses, smart clothes, smart jewelry, and/or the like. As illustrated, each participating device 250A-250N may include one or more components, such as (without limitation): software application 251A-251N having participation engine 253A-N and user interface 255A-N; and communication logic 257A-N, etc., for allowing and facilitating participation of participating devices 250A-N in online meetings.

Embodiments provide for allowing any of participants 259A-N associated with any of participating devices 250A-N to be absent from an online live meeting for a period of time, choose to listen to the recording of any contents spoken in the live meeting during the participant's absence, and seamlessly transition back from listening to the recording into the live meeting. For example, in one embodiment, this is accomplished using a technique for fast-forwarding the replication of the recorded material through one or more of the following (without limitation): 1) shortening of periods of silence in the recorded conversation; 2) specifying which of the speeches from the meeting to record and/or replay; and 3) fast forwarding, etc.

In one embodiment, identification/authentication logic 201 may be used to identify and authenticate participating devices 250A-N and/or their corresponding users for being participants 259A-N in joining online meetings. In some embodiments, participating devices 250A-N and/or participants 259A-N may be identified and authenticated or verified, prior to and/or during online meetings, using any number and type of identification and authentication parameters, such as user identification (userID), password, biometric finger prints, Internet Protocol (IP) address, etc. Upon identifying and authenticating participating devices 250A-N and the corresponding users, such as participants 259A-N, detection/reception logic 203 may be used to detect each participant 259A-N and their participating device 250A-N and their attempts at joining online meetings.

As will be further described later, in one embodiment, seamless meeting mechanism 110 may further include preference logic 205 in communication with participation engine 253A-N at participating devices 251A-N over one or more networks, such as network(s) 240 (e.g., Cloud network, the Internet, proximity network, etc.) to allow for receiving and managing user preferences regarding online meetings and their participation in seamless transitioning into and out of meetings (“seamless meetings” or “seamless transitioning”) as facilitated by seamless meeting mechanism 110. For example, participant 259A associated with participating device 251A may not wish to have their voice recorded and thus participant 259A may choose to set their user preferences, using participation engine 253A as provided by user interface 253A, to decline or opt-out of any recordings of her speech.

It is contemplated that any one or more of participants 259A-N may choose to decline recording of their speech for any number of reasons, such as privacy, confidential nature of speech contents, etc., and accordingly, some participants 259A-N may choose to opt-in and opt-out of recordings and participation in seamless transitioning depending on their varying reasons, while some other participants 259A-N may choose to participate or not participate on a more consistent basis.

It is contemplated that this choice of participation is not limited to deciding in advance or as provided through preference logic 205, but that in one embodiment any of participants 259A-N may choose or decide, in real-time, whether to participate or decline to participate in recordings to be used for seamless meetings as facilitated by selection/filtering logic 207. Further, in one embodiment and using selection/filtering logic 207, even the participant, such as participant 259A, who is on the receiving end of seamless meetings, such as participant 259A who disengages and returns to the meeting and listens to the recording of the missed portion of the meeting in an attempt to transition back into live meeting, may also pick and choose in real-time, such as choosing not to listen to one or more speakers or certain sections of the recordings.

As aforementioned, seamless meeting mechanism 110 allows for meeting participants 259A-N to seamlessly transition from the recorded portion of the meeting into the live ongoing conversation by intelligently fast forwarding replication of the recorded material through a combination of techniques, such as shortening of silence periods, selecting of relevant speakers, etc. In one embodiment, recording engine 211, including its various components 213-217, provides for recording a period of live meeting that is missed by participant 259A when the participant 259A chooses to disengage the live meeting and returns back to it after a period of time.

For example and in one embodiment, user A associated with participating device 250A may choose to disengage from a live meeting for a given period of time (e.g., 15 minutes), where this disengagement may be preplanned or done instantly, such as in response to an emergency. In case of the disengagement being preplanned, using participation engine 253A and via user interface 255A, participant 259A may choose, in advance, a specific time (e.g., 2:45 PM-3:00 PM) for absence and select to participate in seamless transition back to the live meeting. This entry may then be communicated, via communication logic 257A and communication/compatibility logic 231 over network 240, to seamless meeting mechanism 110 where it is received by detection/reception logic 203 and forwarded on to preferences logic 205 and selection/filtering logic 207 for further processing.

In another embodiment, if participant 259A's decision to disengage from the live meeting is a sudden one (such as upon remembering a task, encountering an emergency, or needing to go to the bathroom, etc.), participant 259A may immediately request that the proceedings of the live meeting be recorded by simply clicking on button or accessing a webpage by going to a link provided via user interface 255A and as supported by participation engine 253A.

In either case, once the request is received, recording engine 211 is then triggered as broadcasting logic 215 prepares and sends a broadcast to other participants 259B and 259N, where the broadcast is about participant 259A's absence from the meeting and the potential recording of the proceedings of the meeting during the absence. For example, in one embodiment, broadcast is to make the present participants 259B and 259N aware of potential recording of their speech, while allowing them to opt-out of the seamless meeting process if they did not wish to be recorded. Any one or more of participants 259B-N may choose not to have their speech recorded by clicking on a butting or accessing a webpage through their respective user interfaces 257B-N as facilitated by participation engine 253B-N.

Meanwhile, in one embodiment, recording logic 213 may begin to record the proceedings of the meeting (such as speeches of the current participants, such as participants 259B-N) while participant 259A is absent from the meeting. For example and in one embodiment, as facilitated by recording logic 213, all conversations from the live meeting participants 259B-N may be recorded, except for the speech or conversations of those participants who may have chosen to opt-out from being recorded (although they may have chosen to stay in the meeting). In one embodiment, this recording process may continue until the missing participant, such as participant 259A, has returned, caught up with the missed content, and transitioned back into the meeting. In some embodiments, the recording may continue to for a predefined time period, such as 15 minutes, as requested by the disengaging participant 259A.

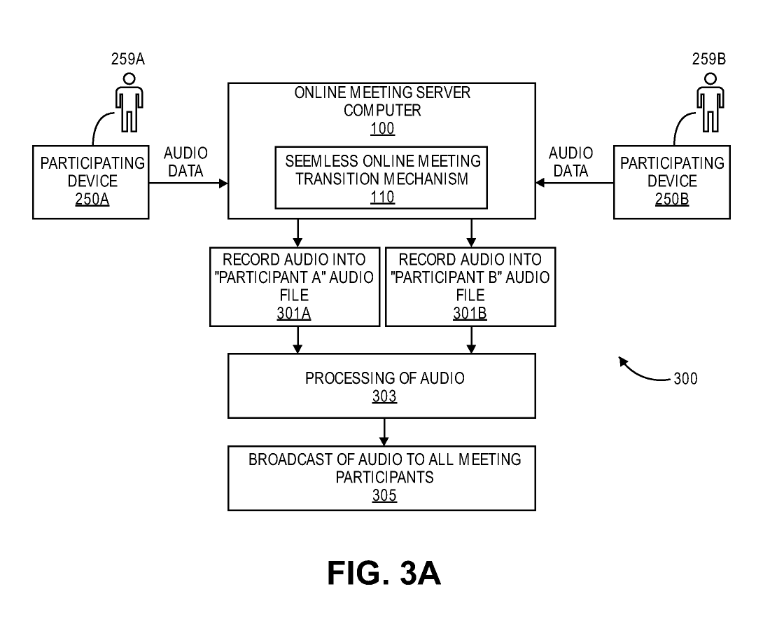

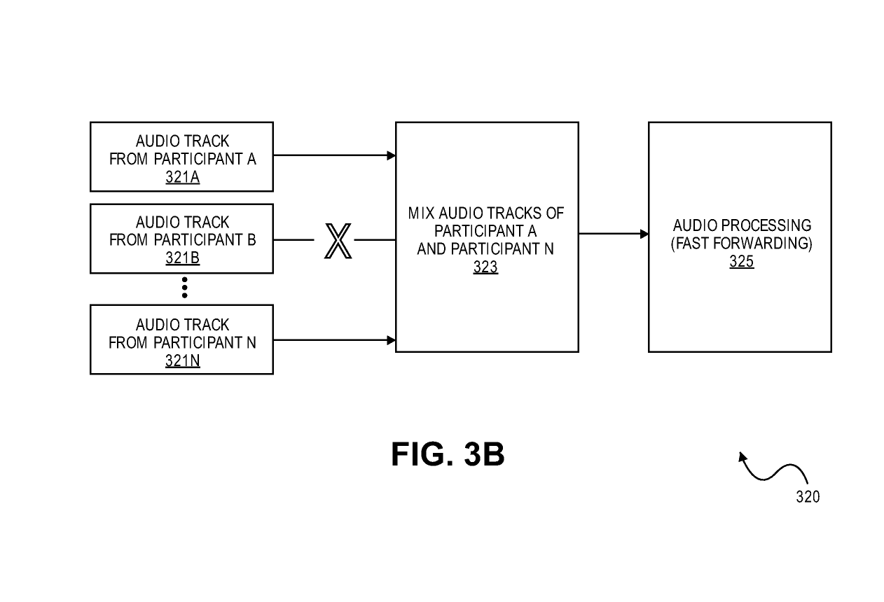

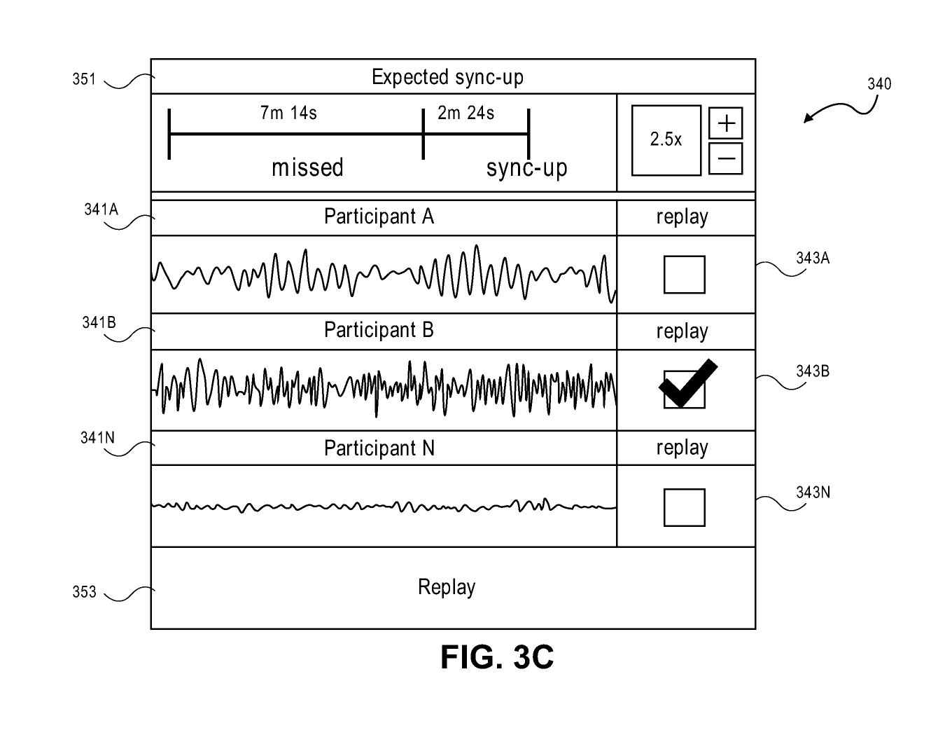

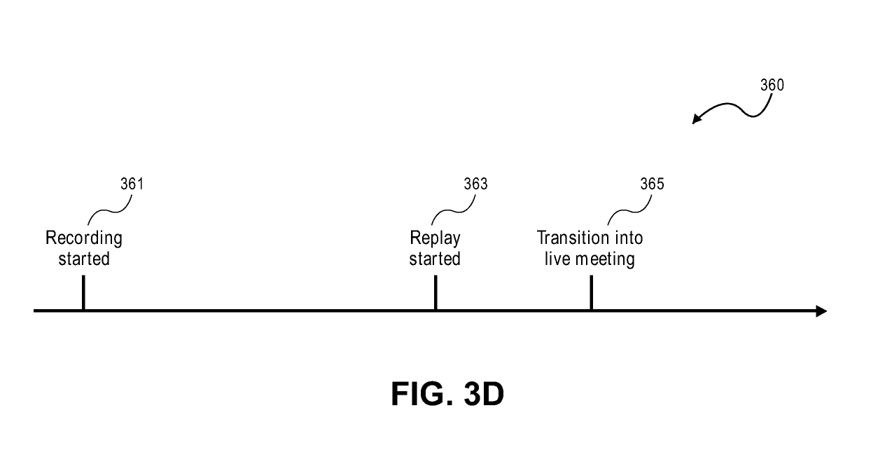

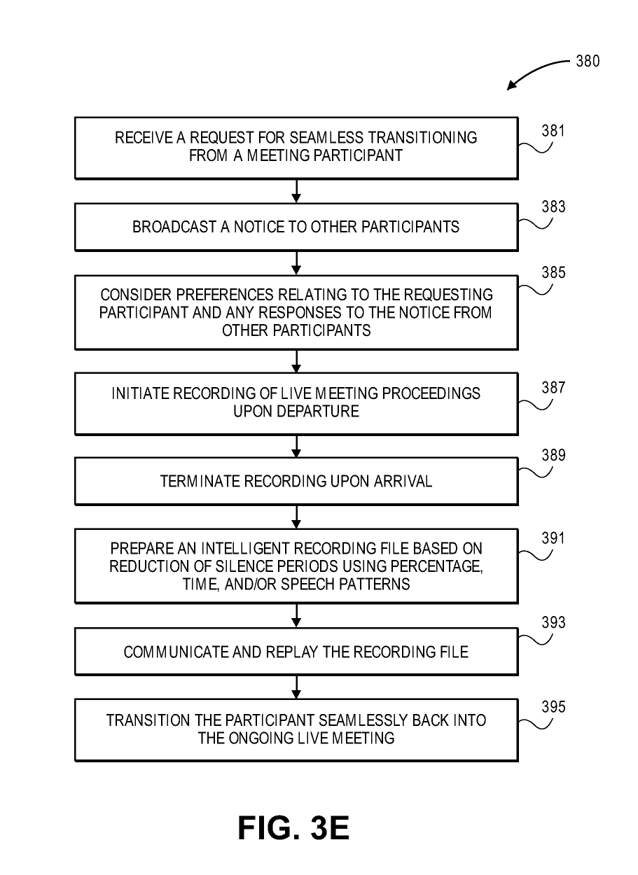

As illustrated, recording engine 211 further includes processing logic 217 to perform any necessary processing of the recording, such as placing and saving each participant 259A-N's own track/audio/video file (also referred to as “recording file”), such as a copy of the recording may be saved in each of recording files A-N corresponding and assigned to participants 259A-N, respectively, where these recording files may be stored by and maintained at computing device 100, such as stored at database 245. This technique allows each participant 259A-N to have their own copy of the recording that they can partially or fully listen to, watch, and/or discard as further illustrated with reference to FIG. 3A. In another embodiment, copies of the recording may be sent to and stored at local memory devices associated with participating devices 250A-N. In some embodiments, any recording files may be stored by computing device 100 before they are communicated over to participating devices 250A-N. Once these track files are stored, centrally or locally, a message is broadcast, via broadcast logic 215, to each participant 259A-N via their corresponding participant devices 250A-N so that participants 259A-N may be made aware of the availability of such recording files.

As aforementioned, each participant 259A-N may be given an opportunity to opt-out form being recorded; similarly, in one embodiment, the organizer of the meeting, such as participant 259N, may have special authority to choose to interrupt, disable, or stop any or all of the recording process or simply delete any or all portions of the recording file for any number and type of reasons, such as overall confidential nature of the meeting, sensitive discussion, personal details about an individual, etc. Further, as discussed above, if an individual participant, such as participant 259B, does not wish to participate in seamless transitioning, participant 259B may turn off the audio and/or video track by clicking on a button or accessing a website via user interface 255B at participating device 250B. It is contemplated that embodiments are not limited to any particular privacy and/or security measure or technique and that any number and type of privacy/security techniques may be employed.

Upon performing recording tasks, replaying engine 221 may be triggered to perform its tasks, such as intelligently replaying the recording in a manner as to allow the absent participant, such participant 259A, to catch up on the missed conversations from the live meeting by watching/listening to the recording at a given speed so as to seamlessly transition back into the live meeting. For example and in one embodiment, in order to catch up with the missed material and seamlessly transition back into the ongoing live meeting, the recording may be replayed to participant 259A at a rate faster than the rate at which it was recorded. In one embodiment, this faster rate may be done intelligently and achieved through one or more of: 1) filtering out one or more participants 259A-N from being recorded or simply filtering out their recording files; 2) shortening of the silence periods from the meeting; and 3) fast-forwarding the material, etc.

In one embodiment, removing or filtering out one or more participants 259A-N or their recordings may lead to speeding up of replaying of the recording. For example and in one embodiment, participant 259A may choose to filter out one or more remaining participants 259B-N, such as filtering out participant 259B, by simply requesting to filter out participant 259B or select other participants, such as participant 259N, to be included in the recording. As is illustrated with respect to FIGS. 3A-3B, this task may be accomplished by having participant A simply clicking on a filtering button provided via user interface 255A of software application 251A which may then be converted into a request and communicated on to selection/filtering logic 207 for further processing. If, for example, participant 259B is removed from being recorded, the information may be forwarded on to recording engine 211 such that recording logic 213 is prevented from recording the speech associated with participant 259B. If, for example, participant 259A requests that the recording of participant 259B is to be filtered out, this information may then be communicated on to replaying engine 221 which skips over the recording of participant 259B.

In lieu of or addition to filtering out one or more participants, such as filtering out participant 259B, faster replay speed may also be achieved through reduction of silence period experienced throughout the recording period. For example and in one embodiment, silence and speed management logic 223 may be used to achieve a faster speed by reducing the silence periods that are experienced during conversations. It is natural to have any number of silence periods or pauses when an individual is speaking or when two or more individuals are conversing, such as between words, sentences, arguments, etc. In one embodiment, silence and speed management logic 223 detects such silence periods throughout entire conversation taking place during the period of absence and works to entirely eliminate or sufficiently reduce the silence periods by an amount of percentage and/or time, etc., without compromising any of the non-silent portions of the conversation that are captured on the recording.

In one embodiment, the reduction may be percentage based, such as silence and speed management logic 223 may detect any number of silence periods and choose to reduce each of them by a suitable amount of percentage, such as 80%, where the suitable amount refers to an amount that does not compromise the non-silent portions of the recording. Similarly, in one embodiment, silence and speed management logic 223 may reduce each silence period by reducing it by a suitable amount of time, such as 1 second, where the suitable amount refers to an amount that does not compromise the non-silent portions of the recording.

In either case, as non-essential content (e.g., silence) is reduced, the speed of the recording is proportionally increased, making it faster for participant 259A to listen to the recording and seamlessly transition back into the live meeting. For example, the original conversation conducted over 15 minutes may be intelligently reduced to 10 minutes, making it 5 minutes faster for participant 259A to catch up on the missed material and transition back into the ongoing live meeting. In some embodiment, both the percentage and time reductions may be applied to the recording, while in some cases neither may be applied. Whether percentage, time, both, or neither is chosen may be predetermined or selected by the organizer of the meeting, the majority of participants 259A-N, and/or the absent participant, such as participant 259A.

In one embodiment, speech pattern management logic 225 may be used to determined and analyze speech patterns and behavior of each participant 259A-N to achieve and apply a participant-tailored silence reduction technique. For example, it is contemplated that each individual has a natural manner of talking, such as a particular way of pausing after certain words, phrases, etc., during normal speech as opposed to when the individual is experiencing an emotional outburst or is simply uninterested in the conversation, etc. It is therefore further contemplated that the same sentence spoken by two individuals, such as participants 259A and 259N, may be sufficiently different from each other.

To capture this variance, certain behaviors, such as the pause behavior (e.g., pauses between words, sentences, etc.) of participants 259A-N may be detected and analyzed by speech pattern management logic 225, where this data may be stored at database 245 for each participant 259A-N such that this information may be applied to achieve speed reduction. For example, for each participant 259A-N, database 245 may contain a tuple <words, min_pause, max_pause, average_pause, standard_deviation_pause> which may be developed during a training session using pre-defined sets of training texts. Further, during the replay state, one of the pause values (e.g., min-pause) may be used for each word and sentence to achieve the desired speed for the selected participant, such as participant 259A.

Further, in one embodiment and as illustrated with reference to FIGS. 3C-3D, time and prediction logic 227 of replaying engine 221 may be used to compute and predict for the benefit of the participant, such as participant 259A, the amount of time it may take to replay a recording and that amount of time may be altered (e.g., lowered) if certain changes are made to the criteria associated with the recording, such as if one or more participants or their recordings are filtered out, etc. Such indicators may be provided to participants 259A-N via user interfaces 255A-N at their corresponding participant devices 250A-N.

Capturing/sensing components at computing device 100 may include any number and type of capturing/sensing devices, such as one or more sending and/or capturing devices (e.g., cameras (e.g., three-dimension (3D) cameras, etc.), microphones, vibration components, tactile components, conductance elements, biometric sensors, chemical detectors, signal detectors, wave detectors, force sensors (e.g., accelerometers), illuminators, etc.) that may be used for capturing any amount and type of visual data, such as images (e.g., photos, videos, movies, audio/video streams, etc.), and non-visual data, such as audio streams (e.g., sound, noise, vibration, ultrasound, etc.), radio waves (e.g., wireless signals, such as wireless signals having data, metadata, signs, etc.), chemical changes or properties (e.g., humidity, body temperature, etc.), biometric readings (e.g., figure prints, etc.), environmental/weather conditions, maps, etc. It is contemplated that “sensor” and “detector” may be referenced interchangeably throughout this document. It is further contemplated that one or more capturing/sensing components may further include one or more supporting or supplemental devices for capturing and/or sensing of data, such as illuminators (e.g., infrared (IR) illuminator), light fixtures, generators, sound blockers, etc.

It is further contemplated that in one embodiment, capturing/sensing components of computing device 100 may further include any number and type of sensing devices or sensors (e.g., linear accelerometer) for sensing or detecting any number and type of contexts (e.g., estimating horizon, linear acceleration, etc., relating to a mobile computing device, etc.). For example, capturing/sensing components may include any number and type of sensors, such as (without limitations): accelerometers (e.g., linear accelerometer to measure linear acceleration, etc.); inertial devices (e.g., inertial accelerometers, inertial gyroscopes, micro-electro-mechanical systems (MEMS) gyroscopes, inertial navigators, etc.); gravity gradiometers to study and measure variations in gravitation acceleration due to gravity, etc.

For example, capturing/sensing components may further include (without limitations): audio/visual devices (e.g., cameras, microphones, speakers, etc.); context-aware sensors (e.g., temperature sensors, facial expression and feature measurement sensors working with one or more cameras of audio/visual devices, environment sensors (such as to sense background colors, lights, etc.), biometric sensors (such as to detect fingerprints, etc.), calendar maintenance and reading device), etc.; global positioning system (GPS) sensors; resource requestor; and trusted execution environment (TEE) logic. TEE logic may be employed separately or be part of resource requestor and/or an I/O subsystem, etc. Capturing/sensing components may further include voice recognition devices, photo recognition devices, facial and other body recognition components, voice-to-text conversion components, etc.

Computing device 100 may further include one or more output components to remain in communication with one or more capturing/sensing components and one or more components of seamless meeting mechanism 110 to facilitate displaying of images, playing or visualization of sounds, displaying visualization of fingerprints, presenting visualization of touch, smell, and/or other sense-related experiences, etc. For example and in one embodiment, output components may include (without limitation) one or more of light sources, display devices and/or screens (e.g., two-dimension (2D) displays, 3D displays, etc.), audio speakers, tactile components, conductance elements, bone conducting speakers, olfactory or smell visual and/or non/visual presentation devices, haptic or touch visual and/or non-visual presentation devices, animation display devices, biometric display devices, X-ray display devices, etc.

In the illustrated embodiment, computing device 100 is shown as hosting seamless meeting mechanism 110; however, it is contemplated that embodiments are not limited as such and that in another embodiment, seamless meeting mechanism 110 may be entirely or partially hosted by multiple or a combination of computing devices, such as computing devices 100, 250A-250N; however, throughout this document, for the sake of brevity, clarity, and ease of understanding, seamless meeting mechanism 110 is shown as being hosted by computing device 100.

In the illustrated embodiment, participating devices 250A-250N may include wearable devices hosting one or more software applications 251A-N (e.g., device applications, hardware components applications, business/social application, websites, etc.) in communication with seamless meeting mechanism 110, where software applications 251A-N may offer one or more user interfaces 255A-N (e.g., web user interface (WUI), graphical user interface (GUI), touchscreen, etc.) to work with and/or facilitate one or more operations or functionalities of seamless meeting mechanism 110, such as displaying one or more images, videos, etc., playing one or more sounds, etc., via one or more input/output sources 108 of FIG. 1.

In one embodiment, participating devices 250A-250N may include one or more of smartphones and tablet computers that their corresponding users may carry in their hands. In another embodiment, participating devices 250A-250N may include wearable devices, such as one or more of wearable glasses, binoculars, watches, bracelets, etc., that their corresponding users may hold in their hands or wear on their bodies, etc. In yet another embodiment, participating devices 250A-250N may include other forms of wearable devices, such as one or more of clothing items, flexible wraparound wearable devices, etc., that may be of any shape or form that their corresponding users may be able to wear on their various body parts, such as knees, arms, wrists, hands, etc.

Communication/compatibility logic 231 may be used to facilitate dynamic communication and compatibility between computing device 100 and participating devices 250-250N and any number and type of other computing devices (such as wearable computing devices, mobile computing devices, desktop computers, server computing devices, etc.), processing devices (e.g., central processing unit (CPU), graphics processing unit (GPU), etc.), capturing/sensing components (e.g., non-visual data sensors/detectors, such as audio sensors, olfactory sensors, haptic sensors, signal sensors, vibration sensors, chemicals detectors, radio wave detectors, force sensors, weather/temperature sensors, body/biometric sensors, scanners, etc., and visual data sensors/detectors, such as cameras, etc.), user/context-awareness components and/or identification/verification sensors/devices (such as biometric sensors/detectors, scanners, etc.), memory or storage devices, data sources, and/or database(s) 245 (such as data storage devices, hard drives, solid-state drives, hard disks, memory cards or devices, memory circuits, etc.), network(s) 240 (e.g., Cloud network, the Internet, intranet, cellular network, proximity networks, such as Bluetooth, Bluetooth low energy (BLE), Bluetooth Smart, Wi-Fi proximity, Radio Frequency Identification (RFID), Near Field Communication (NFC), Body Area Network (BAN), etc.), wireless or wired communications and relevant protocols (e.g., Wi-Fi®, WiMAX, Ethernet, etc.), connectivity and location management techniques, software applications/websites, (e.g., social and/or business networking websites, business applications, games and other entertainment applications, etc.), programming languages, etc., while ensuring compatibility with changing technologies, parameters, protocols, standards, etc.

Throughout this document, terms like “logic”, “component”, “module”, “framework”, “engine”, “tool”, and the like, may be referenced interchangeably and include, by way of example, software, hardware, and/or any combination of software and hardware, such as firmware. Further, any use of a particular brand, word, term, phrase, name, and/or acronym, such as “seamless transitioning”, “seamless meeting”, “recording”, “replaying”, “participant”, “participation”, “filtering”, “participating device”, “personal device”, “smart device”, “mobile computer”, “wearable device”, etc., should not be read to limit embodiments to software or devices that carry that label in products or in literature external to this document.

It is contemplated that any number and type of components may be added to and/or removed from seamless meeting mechanism 110 to facilitate various embodiments including adding, removing, and/or enhancing certain features. For brevity, clarity, and ease of understanding of seamless meeting mechanism 110, many of the standard and/or known components, such as those of a computing device, are not shown or discussed here. It is contemplated that embodiments, as described herein, are not limited to any particular technology, topology, system, architecture, and/or standard and are dynamic enough to adopt and adapt to any future changes.

FIG. 3A illustrates a transaction sequence 300 for recording, processing, and broadcasting of speech data as facilitated by seamless online meeting transitioning mechanism 110 of FIGS. 1-2 according to one embodiment. As an initial matter, for brevity, clarity, and ease of understanding, many of the components and processes discussed above with reference to FIGS. 1-2 may not be repeated or discussed hereafter. Transaction sequence 300 may be performed by processing logic that may comprise hardware (e.g., circuitry, dedicated logic, programmable logic, etc.), software (such as instructions run on a processing device), or a combination thereof. In one embodiment, transaction sequence may be performed by online meeting mechanism 110 of FIGS. 1-2. The processes of transaction sequence 300 are illustrated in linear sequences for brevity and clarity in presentation; however, it is contemplated that any number of them can be performed in parallel, asynchronously, or in different orders. For brevity, many of the details discussed with reference to the previous figures may not be discussed or repeated hereafter.

In the illustrated embodiment, participating device 250A and 250B having software applications 251A and 251B, respectively, are shown to be in communication with online meeting server computer 100 having seamless meeting mechanism 110, wherein speech data (e.g., audio data) relating to participants 259A and 259B associated with participating devices 250A and 250B, respectively, is received at server computer 100. In one embodiment, this audio data relating to participants 259A and 259B associated with participating devices 250A and 250B, respectively, is processed by seamless meeting mechanism 110 at server computer 100 such that the respective audio segments are recorded into their corresponding files, such as audio files 301A and 301B relating to participants 259A and 259B, respectively.

Further, audio files 301A, 301B are processed, at 303, to make them faster and based on any preferences and/or requests relating to participants 259A and 259B and/or participating devices 250A and 250B, such as removing or reducing silence periods from recordings of audio files 301A, 301B, removing certain segments of the recordings spoken by another participant as requested by one or more of participants 259A and 259B, etc. Upon processing of audio files 303, audio files 301A, 301B are broadcast, at 305, to all meeting participants, including participants 259A and 259B, via their respectively participating devices, including participating devices 250A and 250B.

FIG. 3B illustrates a transaction sequence 320 for selection and filtering out of recording tracks as facilitated by seamless online meeting transitioning mechanism 110 of FIGS. 1-2 according to one embodiment. Transaction sequence 320 may be performed by processing logic that may comprise hardware (e.g., circuitry, dedicated logic, programmable logic, etc.), software (such as instructions run on a processing device), or a combination thereof. In one embodiment, transaction sequence may be performed by online meeting mechanism 110 of FIGS. 1-2. The processes of transaction sequence 320 are illustrated in linear sequences for brevity and clarity in presentation; however, it is contemplated that any number of them can be performed in parallel, asynchronously, or in different orders. For brevity, many of the details discussed with reference to the previous figures may not be discussed or repeated hereafter.

Transaction sequence 320 relates to a replay stage where speech samples from audio tracks 321A, 321B and 321N relating to various participants 359A, 359B and 359N, respectively, of FIG. 2, and prepared to be mixed into a proper recording of speech samples. In one embodiment, as discussed with reference to FIG. 2, a participant may be allowed to select to have speeches relating to any one or more of other participants removed if they do not wish to listen to them when the final recording is replayed. For example, as illustrated, a visual indicator listing speech activity of each participant may be provided to the participant who may choose to remove, for example, audio track 321B relating to participant B, such as participant 259B of FIG. 2. Accordingly, in one embodiment, audio track 321B is removed while the remaining audio tracks 321A and 321N are mixed at 323 and processed (e.g., fast forwarding, removing silence periods, etc.) at 325.

FIG. 3C illustrates a screen shot 340 of transaction sequence 320 of FIG. 3B as facilitated by seamless online meeting transitioning mechanism 110 of FIGS. 1-2 according to one embodiment. As discussed with reference to FIG. 3B, a participant may be allowed to select any one or more of other participants for removal such that the speech of removed participants may not be included in the final recording. In the illustrated embodiment, the participant is provided a list of participant names 321A-N via a user interface, such as user interfaces 255A-N of FIG. 2. In one embodiment, participant names 321A-N are provided along with corresponding replay checkboxes 343A-N next to them such that participant can check any box, such as box 343B, to select the corresponding participant's name, such as participant B 341N, to be removed from having their speech included in the replay of the final recording. Further, upon clicking on replay 353, the participant may play the recording.

In one embodiment, top portion 351 provides additional information, such as expected sync-up that predictively, as facilitated by time and prediction logic 227 of FIG. 2, provides the amount of time (e.g., 2 minutes, 24 seconds) it may take the participant to sync-up to transition into the ongoing live meeting if the participant stays true to the selection of filtering out from the final recording any talks given by participant B 341B. Top portion 351 further illustrates an amount of time (e.g., 7 minutes, 14 seconds) missed during the participant's absence from the live meeting, but that loss may be recovered in the sync-up time of 2 minutes, 24 seconds and the participant may seamlessly rejoin the ongoing live meeting.

FIG. 3D illustrates a transaction sequence 360 of recording, replaying, and transitioning as facilitated by seamless online meeting transitioning mechanism 110 of FIGS. 1-2 according to one embodiment. Transaction sequence 360 may be performed by processing logic that may comprise hardware (e.g., circuitry, dedicated logic, programmable logic, etc.), software (such as instructions run on a processing device), or a combination thereof. In one embodiment, transaction sequence may be performed by online meeting mechanism 110 of FIGS. 1-2. The processes of transaction sequence 360 are illustrated in linear sequences for brevity and clarity in presentation; however, it is contemplated that any number of them can be performed in parallel, asynchronously, or in different orders. For brevity, many of the details discussed with reference to the previous figures may not be discussed or repeated hereafter.

As discussed with reference to FIG. 3D and earlier with reference to FIG. 2, in one embodiment, by shortening the recording (such as by removing or reducing silence periods, etc.), the replay stage may be far shorter that the recording stage to allow a participant a seamless and quick transition back into the ongoing live meeting (after disengaging from the meeting for a period of time). As illustrated here, in one embodiment, the recording stage begins at with the start of recording 361 upon disengagement of the participant from the live meeting and may continue upon the participants return to the meeting or per a predetermined time period or, in some case, at a break or end of the meeting.

In one embodiment, upon the participants return, the recording stage ends and replay stage begins with the start of replaying 363 of the recording of the meeting proceedings obtained during the recording stage. As illustrated, the replay stage may end when the participant is seamlessly transitioned back 365 into the live proceedings of the meeting. As illustrated here and further discussed with reference to FIG. 3D, the replay stage may be much shorter (such as 2 minutes, 24 seconds as shown in FIG. 3C) than the recording stage (such as 7 minutes, 13 seconds as shown in FIG. 3C) to allow for a quick and seamless transition back into the live meeting without losing out on any of the proceedings that may have taken place during the participant's absence.

FIG. 3E illustrates a method 380 for seamless transitioning into online meetings as facilitated by seamless online meeting transitioning mechanism 110 of FIGS. 1-2 according to one embodiment. Method 380 may be performed by processing logic that may comprise hardware (e.g., circuitry, dedicated logic, programmable logic, etc.), software (such as instructions run on a processing device), or a combination thereof. In one embodiment, transaction sequence may be performed by online meeting mechanism 110 of FIGS. 1-2. The processes of method 380 are illustrated in linear sequences for brevity and clarity in presentation; however, it is contemplated that any number of them can be performed in parallel, asynchronously, or in different orders. For brevity, many of the details discussed with reference to the previous figures may not be discussed or repeated hereafter.

Method 380 begins at block 381 with receiving a request for seamless transitioning from one of the participants of a live meeting. In one embodiment, the request from the participant may include details of the participant wanting to disengage from the live meeting for a period of time and catch up on any proceedings taking place during the absence while transitioning back into the meeting. At block 383, a notice regarding the participant's disengagement and the potential recording of the proceedings during the absence is sent to all other participants, allowing them to, for example, opt-out of the recording process in response to the notice, etc. At block 385, any user preferences of the participant and other participants along with any responses (e.g., opting-out requests, etc.) to the notice are taken into consideration.

At block 387, in one embodiment, based on the user preferences and any responses to the notice, recording of the proceedings of the live meeting is initiated upon disengagement of the participant. At block 389, the recording is terminated upon arrival of the participant. At block 391, an intelligent recording file including the recording is generated based on reduction silence periods using one or more of percentage-based reduction, time-based reduction, and speech patterns. At block 393, the recording file is communicated and replayed. At block 395, the participant is seamlessly transitioned back into the ongoing live meeting upon listening through the recording.

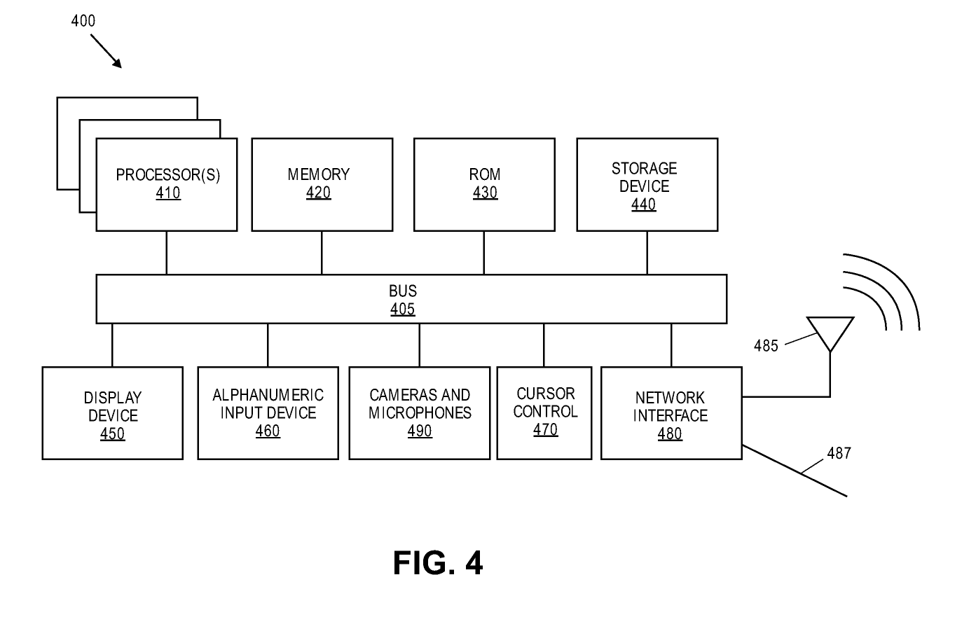

FIG. 4 illustrates an embodiment of a computing system 400 capable of supporting the operations discussed above. Computing system 400 represents a range of computing and electronic devices (wired or wireless) including, for example, desktop computing systems, laptop computing systems, cellular telephones, personal digital assistants (PDAs) including cellular-enabled PDAs, set top boxes, smartphones, tablets, wearable devices, etc. Alternate computing systems may include more, fewer and/or different components. Computing device 400 may be the same as or similar to or include computing devices 100 described in reference to FIG. 1.

Computing system 400 includes bus 405 (or, for example, a link, an interconnect, or another type of communication device or interface to communicate information) and processor 410 coupled to bus 405 that may process information. While computing system 400 is illustrated with a single processor, it may include multiple processors and/or co-processors, such as one or more of central processors, image signal processors, graphics processors, and vision processors, etc. Computing system 400 may further include random access memory (RAM) or other dynamic storage device 420 (referred to as main memory), coupled to bus 405 and may store information and instructions that may be executed by processor 410. Main memory 420 may also be used to store temporary variables or other intermediate information during execution of instructions by processor 410.

Computing system 400 may also include read only memory (ROM) and/or other storage device 430 coupled to bus 405 that may store static information and instructions for processor 410. Date storage device 440 may be coupled to bus 405 to store information and instructions. Date storage device 440, such as magnetic disk or optical disc and corresponding drive may be coupled to computing system 400.

Computing system 400 may also be coupled via bus 405 to display device 450, such as a cathode ray tube (CRT), liquid crystal display (LCD) or Organic Light Emitting Diode (OLED) array, to display information to a user. User input device 460, including alphanumeric and other keys, may be coupled to bus 405 to communicate information and command selections to processor 410. Another type of user input device 460 is cursor control 470, such as a mouse, a trackball, a touchscreen, a touchpad, or cursor direction keys to communicate direction information and command selections to processor 410 and to control cursor movement on display 450. Camera and microphone arrays 490 of computer system 400 may be coupled to bus 405 to observe gestures, record audio and video and to receive and transmit visual and audio commands.

Computing system 400 may further include network interface(s) 480 to provide access to a network, such as a local area network (LAN), a wide area network (WAN), a metropolitan area network (MAN), a personal area network (PAN), Bluetooth, a cloud network, a mobile network (e.g., 3^{rd} Generation (3G), etc.), an intranet, the Internet, etc. Network interface(s) 480 may include, for example, a wireless network interface having antenna 485, which may represent one or more antenna(e). Network interface(s) 480 may also include, for example, a wired network interface to communicate with remote devices via network cable 487, which may be, for example, an Ethernet cable, a coaxial cable, a fiber optic cable, a serial cable, or a parallel cable.

Network interface(s) 480 may provide access to a LAN, for example, by conforming to IEEE 802.11b and/or IEEE 802.11g standards, and/or the wireless network interface may provide access to a personal area network, for example, by conforming to Bluetooth standards. Other wireless network interfaces and/or protocols, including previous and subsequent versions of the standards, may also be supported.

In addition to, or instead of, communication via the wireless LAN standards, network interface(s) 480 may provide wireless communication using, for example, Time Division, Multiple Access (TDMA) protocols, Global Systems for Mobile Communications (GSM) protocols, Code Division, Multiple Access (CDMA) protocols, and/or any other type of wireless communications protocols.

Network interface(s) 480 may include one or more communication interfaces, such as a modem, a network interface card, or other well-known interface devices, such as those used for coupling to the Ethernet, token ring, or other types of physical wired or wireless attachments for purposes of providing a communication link to support a LAN or a WAN, for example. In this manner, the computer system may also be coupled to a number of peripheral devices, clients, control surfaces, consoles, or servers via a conventional network infrastructure, including an Intranet or the Internet, for example.

It is to be appreciated that a lesser or more equipped system than the example described above may be preferred for certain implementations. Therefore, the configuration of computing system 400 may vary from implementation to implementation depending upon numerous factors, such as price constraints, performance requirements, technological improvements, or other circumstances. Examples of the electronic device or computer system 400 may include without limitation a mobile device, a personal digital assistant, a mobile computing device, a smartphone, a cellular telephone, a handset, a one-way pager, a two-way pager, a messaging device, a computer, a personal computer (PC), a desktop computer, a laptop computer, a notebook computer, a handheld computer, a tablet computer, a server, a server array or server farm, a web server, a network server, an Internet server, a work station, a mini-computer, a main frame computer, a supercomputer, a network appliance, a web appliance, a distributed computing system, multiprocessor systems, processor-based systems, consumer electronics, programmable consumer electronics, television, digital television, set top box, wireless access point, base station, subscriber station, mobile subscriber center, radio network controller, router, hub, gateway, bridge, switch, machine, or combinations thereof.

Embodiments may be implemented as any or a combination of: one or more microchips or integrated circuits interconnected using a parentboard, hardwired logic, software stored by a memory device and executed by a microprocessor, firmware, an application specific integrated circuit (ASIC), and/or a field programmable gate array (FPGA). The term “logic” may include, by way of example, software or hardware and/or combinations of software and hardware.

Embodiments may be provided, for example, as a computer program product which may include one or more machine-readable media having stored thereon machine-executable instructions that, when executed by one or more machines such as a computer, network of computers, or other electronic devices, may result in the one or more machines carrying out operations in accordance with embodiments described herein. A machine-readable medium may include, but is not limited to, floppy diskettes, optical disks, CD-ROMs (Compact Disc-Read Only Memories), and magneto-optical disks, ROMs, RAMs, EPROMs (Erasable Programmable Read Only Memories), EEPROMs (Electrically Erasable Programmable Read Only Memories), magnetic or optical cards, flash memory, or other type of media/machine-readable medium suitable for storing machine-executable instructions.

Moreover, embodiments may be downloaded as a computer program product, wherein the program may be transferred from a remote computer (e.g., a server) to a requesting computer (e.g., a client) by way of one or more data signals embodied in and/or modulated by a carrier wave or other propagation medium via a communication link (e.g., a modem and/or network connection).

References to “one embodiment”, “an embodiment”, “example embodiment”, “various embodiments”, etc., indicate that the embodiment(s) so described may include particular features, structures, or characteristics, but not every embodiment necessarily includes the particular features, structures, or characteristics. Further, some embodiments may have some, all, or none of the features described for other embodiments.

In the following description and claims, the term “coupled” along with its derivatives, may be used. “Coupled” is used to indicate that two or more elements co-operate or interact with each other, but they may or may not have intervening physical or electrical components between them.

As used in the claims, unless otherwise specified the use of the ordinal adjectives “first”, “second”, “third”, etc., to describe a common element, merely indicate that different instances of like elements are being referred to, and are not intended to imply that the elements so described must be in a given sequence, either temporally, spatially, in ranking, or in any other manner.

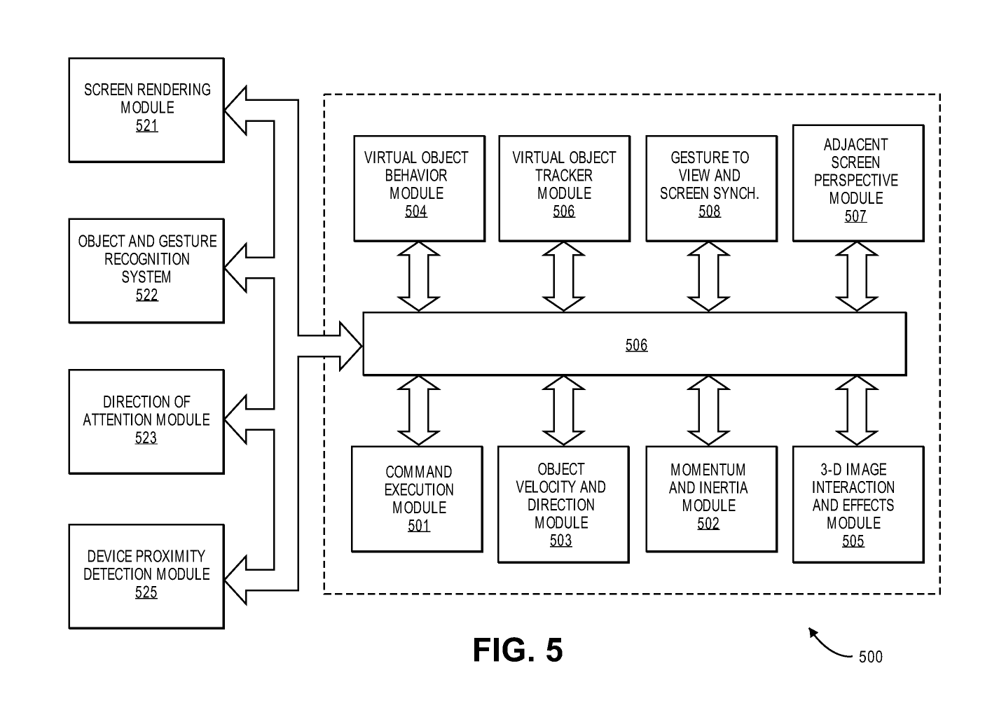

FIG. 5 illustrates an embodiment of a computing environment 500 capable of supporting the operations discussed above. The modules and systems can be implemented in a variety of different hardware architectures and form factors including that shown in FIG. 4.

The Command Execution Module 501 includes a central processing unit to cache and execute commands and to distribute tasks among the other modules and systems shown. It may include an instruction stack, a cache memory to store intermediate and final results, and mass memory to store applications and operating systems. The Command Execution Module may also serve as a central coordination and task allocation unit for the system.

The Screen Rendering Module 521 draws objects on the one or more multiple screens for the user to see. It can be adapted to receive the data from the Virtual Object Behavior Module 504, described below, and to render the virtual object and any other objects and forces on the appropriate screen or screens. Thus, the data from the Virtual Object Behavior Module would determine the position and dynamics of the virtual object and associated gestures, forces and objects, for example, and the Screen Rendering Module would depict the virtual object and associated objects and environment on a screen, accordingly. The Screen Rendering Module could further be adapted to receive data from the Adjacent Screen Perspective Module 507, described below, to either depict a target landing area for the virtual object if the virtual object could be moved to the display of the device with which the Adjacent Screen Perspective Module is associated. Thus, for example, if the virtual object is being moved from a main screen to an auxiliary screen, the Adjacent Screen Perspective Module 2 could send data to the Screen Rendering Module to suggest, for example in shadow form, one or more target landing areas for the virtual object on that track to a user's hand movements or eye movements.

The Object and Gesture Recognition System 522 may be adapted to recognize and track hand and harm gestures of a user. Such a module may be used to recognize hands, fingers, finger gestures, hand movements and a location of hands relative to displays. For example, the Object and Gesture Recognition Module could for example determine that a user made a body part gesture to drop or throw a virtual object onto one or the other of the multiple screens, or that the user made a body part gesture to move the virtual object to a bezel of one or the other of the multiple screens. The Object and Gesture Recognition System may be coupled to a camera or camera array, a microphone or microphone array, a touch screen or touch surface, or a pointing device, or some combination of these items, to detect gestures and commands from the user.

The touch screen or touch surface of the Object and Gesture Recognition System may include a touch screen sensor. Data from the sensor may be fed to hardware, software, firmware or a combination of the same to map the touch gesture of a user's hand on the screen or surface to a corresponding dynamic behavior of a virtual object. The sensor date may be used to momentum and inertia factors to allow a variety of momentum behavior for a virtual object based on input from the user's hand, such as a swipe rate of a user's finger relative to the screen. Pinching gestures may be interpreted as a command to lift a virtual object from the display screen, or to begin generating a virtual binding associated with the virtual object or to zoom in or out on a display. Similar commands may be generated by the Object and Gesture Recognition System using one or more cameras without benefit of a touch surface.

The Direction of Attention Module 523 may be equipped with cameras or other sensors to track the position or orientation of a user's face or hands. When a gesture or voice command is issued, the system can determine the appropriate screen for the gesture. In one example, a camera is mounted near each display to detect whether the user is facing that display. If so, then the direction of attention module information is provided to the Object and Gesture Recognition Module 522 to ensure that the gestures or commands are associated with the appropriate library for the active display. Similarly, if the user is looking away from all of the screens, then commands can be ignored.

The Device Proximity Detection Module 525 can use proximity sensors, compasses, GPS (global positioning system) receivers, personal area network radios, and other types of sensors, together with triangulation and other techniques to determine the proximity of other devices. Once a nearby device is detected, it can be registered to the system and its type can be determined as an input device or a display device or both. For an input device, received data may then be applied to the Object Gesture and Recognition System 522. For a display device, it may be considered by the Adjacent Screen Perspective Module 507.

The Virtual Object Behavior Module 504 is adapted to receive input from the Object Velocity and Direction Module, and to apply such input to a virtual object being shown in the display. Thus, for example, the Object and Gesture Recognition System would interpret a user gesture and by mapping the captured movements of a user's hand to recognized movements, the Virtual Object Tracker Module would associate the virtual object's position and movements to the movements as recognized by Object and Gesture Recognition System, the Object and Velocity and Direction Module would capture the dynamics of the virtual object's movements, and the Virtual Object Behavior Module would receive the input from the Object and Velocity and Direction Module to generate data that would direct the movements of the virtual object to correspond to the input from the Object and Velocity and Direction Module.

The Virtual Object Tracker Module 506 on the other hand may be adapted to track where a virtual object should be located in three dimensional space in a vicinity of an display, and which body part of the user is holding the virtual object, based on input from the Object and Gesture Recognition Module. The Virtual Object Tracker Module 506 may for example track a virtual object as it moves across and between screens and track which body part of the user is holding that virtual object. Tracking the body part that is holding the virtual object allows a continuous awareness of the body part's air movements, and thus an eventual awareness as to whether the virtual object has been released onto one or more screens.

The Gesture to View and Screen Synchronization Module 508, receives the selection of the view and screen or both from the Direction of Attention Module 523 and, in some cases, voice commands to determine which view is the active view and which screen is the active screen. It then causes the relevant gesture library to be loaded for the Object and Gesture Recognition System 522. Various views of an application on one or more screens can be associated with alternative gesture libraries or a set of gesture templates for a given view. As an example in FIG. 1A a pinch-release gesture launches a torpedo, but in FIG. 1B, the same gesture launches a depth charge.

The Adjacent Screen Perspective Module 507, which may include or be coupled to the Device Proximity Detection Module 525, may be adapted to determine an angle and position of one display relative to another display. A projected display includes, for example, an image projected onto a wall or screen. The ability to detect a proximity of a nearby screen and a corresponding angle or orientation of a display projected therefrom may for example be accomplished with either an infrared emitter and receiver, or electromagnetic or photo-detection sensing capability. For technologies that allow projected displays with touch input, the incoming video can be analyzed to determine the position of a projected display and to correct for the distortion caused by displaying at an angle. An accelerometer, magnetometer, compass, or camera can be used to determine the angle at which a device is being held while infrared emitters and cameras could allow the orientation of the screen device to be determined in relation to the sensors on an adjacent device. The Adjacent Screen Perspective Module 507 may, in this way, determine coordinates of an adjacent screen relative to its own screen coordinates. Thus, the Adjacent Screen Perspective Module may determine which devices are in proximity to each other, and further potential targets for moving one or more virtual object's across screens. The Adjacent Screen Perspective Module may further allow the position of the screens to be correlated to a model of three-dimensional space representing all of the existing objects and virtual objects.

The Object and Velocity and Direction Module 503 may be adapted to estimate the dynamics of a virtual object being moved, such as its trajectory, velocity (whether linear or angular), momentum (whether linear or angular), etc. by receiving input from the Virtual Object Tracker Module. The Object and Velocity and Direction Module may further be adapted to estimate dynamics of any physics forces, by for example estimating the acceleration, deflection, degree of stretching of a virtual binding, etc. and the dynamic behavior of a virtual object once released by a user's body part. The Object and Velocity and Direction Module may also use image motion, size and angle changes to estimate the velocity of objects, such as the velocity of hands and fingers

The Momentum and Inertia Module 502 can use image motion, image size, and angle changes of objects in the image plane or in a three-dimensional space to estimate the velocity and direction of objects in the space or on a display. The Momentum and Inertia Module is coupled to the Object and Gesture Recognition System 522 to estimate the velocity of gestures performed by hands, fingers, and other body parts and then to apply those estimates to determine momentum and velocities to virtual objects that are to be affected by the gesture.

The 3D Image Interaction and Effects Module 505 tracks user interaction with 3D images that appear to extend out of one or more screens. The influence of objects in the z-axis (towards and away from the plane of the screen) can be calculated together with the relative influence of these objects upon each other. For example, an object thrown by a user gesture can be influenced by 3D objects in the foreground before the virtual object arrives at the plane of the screen. These objects may change the direction or velocity of the projectile or destroy it entirely. The object can be rendered by the 3D Image Interaction and Effects Module in the foreground on one or more of the displays.

The following clauses and/or examples pertain to further embodiments or examples. Specifics in the examples may be used anywhere in one or more embodiments. The various features of the different embodiments or examples may be variously combined with some features included and others excluded to suit a variety of different applications. Examples may include subject matter such as a method, means for performing acts of the method, at least one machine-readable medium including instructions that, when performed by a machine cause the machine to performs acts of the method, or of an apparatus or system for facilitating hybrid communication according to embodiments and examples described herein.

Some embodiments pertain to Example 1 that includes an apparatus to facilitate dynamic and seamless transitioning into online meetings at computing devices, comprising: detection/reception logic to receive a request from a participant of a plurality of participants of an online meeting, wherein the request indicates disengagement of the participant from the meeting; recording logic of recording engine to initiate recording of proceedings of the online meeting during absence of the participant, wherein the proceedings include conversations of remaining participants of the plurality of participants during the absence of the participant; and replaying engine to intelligently format the recording, wherein the replaying engine is further to replay the formatted recording to the participant while transitioning the participant back into the online meeting.

Example 2 includes the subject matter of Example 1, further comprising broadcasting logic of the recording engine to broadcast, in response to request, a notice to the plurality of participants, wherein the notice offers an opt-out option to allow the plurality of participants to decline participation in the recording of the proceedings.

Example 3 includes the subject matter of Example 1 or 2, further comprising: preferences logic to maintain user preferences of the plurality of participants, wherein the user preferences include instructions from the plurality of participants; and selection/filtering logic to select one or more participants of the plurality of participants, and filter speech relating to the selected one or more participants, wherein the one or more participants are selected based on at least one of one or more of the user preferences and one or more responses to the broadcast notice.

Example 4 includes the subject matter of Example 1, further comprising processing logic of the recording logic to place the recording in one or more tracks associated with one or more participants of the plurality of participants, wherein the formatted recording comprises one or more of an audio recording, a video recording, an image recording, an olfactory recording, and a haptic recording.

Example 5 includes the subject matter of Example 1 or 4, wherein intelligently formatting the recording comprises shortening the recording to facilitate faster replaying of the recording to further facilitate faster transitioning of the participant into the online meeting.

Example 6 includes the subject matter of Example 5, wherein shortening comprises eliminating or reducing, via silence and speed management logic of the replaying engine, a plurality of silence periods from the recording.

Example 7 includes the subject matter of claim 6, wherein the plurality of silence periods are reduced by percentage or time, wherein one or more of the plurality of silence periods are further reduced, via speech pattern management logic of the replaying engine, based on a speech pattern of each of the plurality of participants.

Example 8 includes the subject matter of Example 1, further comprising time and prediction logic of the replaying engine to compute an amount of synchronization time to predict an amount of transition time to perform the transitioning of the participant back into the online meeting.

Example 9 includes the subject matter of Example 8, wherein the synchronization time and the transition time are communicated, via communication/compatibility logic, to the participant prior to replaying the recording.

Example 10 includes the subject matter of Example 1, further comprising identification/authentication logic to identify and authenticate one or more of the requests, the plurality of participants including the participant, and a plurality of computing devices associated with the plurality of participants, wherein the plurality of computing devices comprise at least one of desktop computers and mobile computers including one or more of smartphones, tablet computers, laptops, head-mounted displays, head-mounted gaming displays, wearable glasses, wearable binoculars, smart jewelry, smartwatches, smartcards, and smart clothing items.

Some embodiments pertain to Example 11 that includes a method for facilitating dynamic and seamless transitioning into online meetings at computing devices, comprising: receiving a request from a participant of a plurality of participants of an online meeting, wherein the request indicates disengagement of the participant from the meeting; initiating recording of proceedings of the online meeting during absence of the participant, wherein the proceedings include conversations of remaining participants of the plurality of participants during the absence of the participant; and intelligently formatting the recording, wherein the replaying engine is further to replay the formatted recording to the participant while transitioning the participant back into the online meeting.

Example 12 includes the subject matter of Example 11, further comprising broadcasting, in response to request, a notice to the plurality of participants, wherein the notice offers an opt-out option to allow the plurality of participants to decline participation in the recording of the proceedings.

Example 13 includes the subject matter of Example 11 or 12, further comprising: maintaining user preferences of the plurality of participants, wherein the user preferences include instructions from the plurality of participants; and selecting one or more participants of the plurality of participants, and filtering speech relating to the selected one or more participants, wherein the one or more participants are selected based on at least one of one or more of the user preferences and one or more responses to the broadcast notice.

Example 14 includes the subject matter of Example 11, further comprising placing the recording in one or more tracks associated with one or more participants of the plurality of participants, wherein the formatted recording comprises one or more of an audio recording, a video recording, an image recording, an olfactory recording, and a haptic recording.

Example 15 includes the subject matter of Example 11 or 14, wherein intelligently formatting the recording comprises shortening the recording to facilitate faster replaying of the recording to further facilitate faster transitioning of the participant into the online meeting.

Example 16 includes the subject matter of Example 15, wherein shortening comprises eliminating or reducing a plurality of silence periods from the recording.

Example 17 includes the subject matter of Example 16, wherein the plurality of silence periods are reduced by percentage or time, wherein one or more of the plurality of silence periods are further reduced based on a speech pattern of each of the plurality of participants.

Example 18 includes the subject matter of Example 11, further comprising computing an amount of synchronization time to predict an amount of transition time to perform the transitioning of the participant back into the online meeting.

Example 19 includes the subject matter of Example 18, wherein the synchronization time and the transition time are communicated to the participant prior to replaying the recording.

Example 20 includes the subject matter of Example 11, further comprising identifying and authenticating one or more of the requests, the plurality of participants including the participant, and a plurality of computing devices associated with the plurality of participants, wherein the plurality of computing devices comprise at least one of desktop computers and mobile computers including one or more of smartphones, tablet computers, laptops, head-mounted displays, head-mounted gaming displays, wearable glasses, wearable binoculars, smart jewelry, smartwatches, smartcards, and smart clothing items.

Example 21 includes at least one machine-readable medium comprising a plurality of instructions, when executed on a computing device, to implement or perform a method or realize an apparatus as claimed in any preceding claims or examples.

Example 22 includes at least one non-transitory or tangible machine-readable medium comprising a plurality of instructions, when executed on a computing device, to implement or perform a method or realize an apparatus as claimed in any preceding claims or examples.

Example 23 includes a system comprising a mechanism to implement or perform a method or realize an apparatus as claimed in any preceding claims or examples.

Example 24 includes an apparatus comprising means to perform a method as claimed in any preceding claims or examples.

Example 25 includes a computing device arranged to implement or perform a method or realize an apparatus as claimed in any preceding claims or examples.

Example 26 includes a communications device arranged to implement or perform a method or realize an apparatus as claimed in any preceding claims or examples.

Some embodiments pertain to Example 27 includes a system comprising a storage device having instructions, and a processor to execute the instructions to facilitate a mechanism to perform one or more operations comprising: receiving a request from a participant of a plurality of participants of an online meeting, wherein the request indicates disengagement of the participant from the meeting; initiating recording of proceedings of the online meeting during absence of the participant, wherein the proceedings include conversations of remaining participants of the plurality of participants during the absence of the participant; and intelligently formatting the recording, wherein the replaying engine is further to replay the formatted recording to the participant while transitioning the participant back into the online meeting.

Example 28 includes the subject matter of Example 27, wherein the one or more operations comprise broadcasting, in response to request, a notice to the plurality of participants, wherein the notice offers an opt-out option to allow the plurality of participants to decline participation in the recording of the proceedings.

Example 29 includes the subject matter of Example 27 or 28, wherein the one or more operations comprise: maintaining user preferences of the plurality of participants, wherein the user preferences include instructions from the plurality of participants; and selecting one or more participants of the plurality of participants, and filtering speech relating to the selected one or more participants, wherein the one or more participants are selected based on at least one of one or more of the user preferences and one or more responses to the broadcast notice.

Example 30 includes the subject matter of Example 27, wherein the one or more operations comprise placing the recording in one or more tracks associated with one or more participants of the plurality of participants, wherein the formatted recording comprises one or more of an audio recording, a video recording, an image recording, an olfactory recording, and a haptic recording.

Example 31 includes the subject matter of Example 27 or 30, wherein intelligently formatting the recording comprises shortening the recording to facilitate faster replaying of the recording to further facilitate faster transitioning of the participant into the online meeting.

Example 32 includes the subject matter of Example 31, wherein shortening comprises eliminating or reducing a plurality of silence periods from the recording.

Example 33 includes the subject matter of Example 32, wherein the plurality of silence periods are reduced by percentage or time, wherein one or more of the plurality of silence periods are further reduced based on a speech pattern of each of the plurality of participants.

Example 34 includes the subject matter of Example 27, wherein the one or more operations further comprise computing an amount of synchronization time to predict an amount of transition time to perform the transitioning of the participant back into the online meeting.

Example 35 includes the subject matter of Example 34, wherein the synchronization time and the transition time are communicated to the participant prior to replaying the recording.

Example 36 includes the subject matter of Example 27, wherein the one or more operations further comprise identifying and authenticating one or more of the requests, the plurality of participants including the participant, and a plurality of computing devices associated with the plurality of participants, wherein the plurality of computing devices comprise at least one of desktop computers and mobile computers including one or more of smartphones, tablet computers, laptops, head-mounted displays, head-mounted gaming displays, wearable glasses, wearable binoculars, smart jewelry, smartwatches, smartcards, and smart clothing items.

Some embodiments pertain to Example 37 includes an apparatus comprising: means for receiving a request from a participant of a plurality of participants of an online meeting, wherein the request indicates disengagement of the participant from the meeting; means for initiating recording of proceedings of the online meeting during absence of the participant, wherein the proceedings include conversations of remaining participants of the plurality of participants during the absence of the participant; and means for intelligently formatting the recording, wherein the replaying engine is further to replay the formatted recording to the participant while transitioning the participant back into the online meeting.

Example 38 includes the subject matter of Example 37, further comprising means for broadcasting, in response to request, a notice to the plurality of participants, wherein the notice offers an opt-out option to allow the plurality of participants to decline participation in the recording of the proceedings.

Example 39 includes the subject matter of Example 37 or 38, further comprising: means for maintaining user preferences of the plurality of participants, wherein the user preferences include instructions from the plurality of participants; and means for selecting one or more participants of the plurality of participants, and means for filtering speech relating to the selected one or more participants, wherein the one or more participants are selected based on at least one of one or more of the user preferences and one or more responses to the broadcast notice.

Example 40 includes the subject matter of Example 37, further comprising means for placing the recording in one or more tracks associated with one or more participants of the plurality of participants, wherein the formatted recording comprises one or more of an audio recording, a video recording, an image recording, an olfactory recording, and a haptic recording.

Example 41 includes the subject matter of Example 37 or 40, wherein means for intelligently formatting the recording comprises means for shortening the recording to facilitate faster replaying of the recording to further facilitate faster transitioning of the participant into the online meeting.

Example 42 includes the subject matter of Example 41, wherein shortening comprises eliminating or reducing a plurality of silence periods from the recording.

Example 43 includes the subject matter of Example 42, wherein the plurality of silence periods are reduced by percentage or time, wherein one or more of the plurality of silence periods are further reduced based on a speech pattern of each of the plurality of participants.

Example 44 includes the subject matter of Example 37, further comprising means for computing an amount of synchronization time to predict an amount of transition time to perform the transitioning of the participant back into the online meeting.

Example 45 includes the subject matter of Example 44, wherein the synchronization time and the transition time are communicated to the participant prior to replaying the recording.

Example 46 includes the subject matter of Example 37, further comprising means for identifying and authenticating one or more of the requests, the plurality of participants including the participant, and a plurality of computing devices associated with the plurality of participants, wherein the plurality of computing devices comprise at least one of desktop computers and mobile computers including one or more of smartphones, tablet computers, laptops, head-mounted displays, head-mounted gaming displays, wearable glasses, wearable binoculars, smart jewelry, smartwatches, smartcards, and smart clothing items.

Example 47 includes at least one non-transitory or tangible machine-readable medium comprising a plurality of instructions, when executed on a computing device, to implement or perform a method as claimed in any of claims or examples 11-20.

Example 48 includes at least one machine-readable medium comprising a plurality of instructions, when executed on a computing device, to implement or perform a method as claimed in any of claims or examples 11-20.

Example 49 includes a system comprising a mechanism to implement or perform a method as claimed in any of claims or examples 11-20.

Example 50 includes an apparatus comprising means for performing a method as claimed in any of claims or examples 11-20.

Example 51 includes a computing device arranged to implement or perform a method as claimed in any of claims or examples 11-20.

Example 52 includes a communications device arranged to implement or perform a method as claimed in any of claims or examples 11-20.

The drawings and the forgoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, orders of processes described herein may be changed and are not limited to the manner described herein. Moreover, the actions any flow diagram need not be implemented in the order shown; nor do all of the acts necessarily need to be performed. Also, those acts that are not dependent on other acts may be performed in parallel with the other acts. The scope of embodiments is by no means limited by these specific examples. Numerous variations, whether explicitly given in the specification or not, such as differences in structure, dimension, and use of material, are possible. The scope of embodiments is at least as broad as given by the following claims.

What is claimed is:

1. An apparatus comprising:
detection/reception logic to receive a request from a participant of a plurality of participants of an online meeting, wherein the request indicates disengagement of the participant from the meeting;
recording logic of recording engine to initiate recording of proceedings of the online meeting during absence of the participant, wherein the proceedings include conversations of remaining participants of the plurality of participants during the absence of the participant; and
replaying engine to intelligently format the recording, wherein the replaying engine is further to replay the formatted recording to the participant while transitioning the participant back into the online meeting.

2. The apparatus of claim 1, further comprising broadcasting logic of the recording engine to broadcast, in response to request, a notice to the plurality of participants, wherein the notice offers an opt-out option to allow the plurality of participants to decline participation in the recording of the proceedings.

3. The apparatus of claim 1, further comprising:
preferences logic to maintain user preferences of the plurality of participants, wherein the user preferences include instructions from the plurality of participants; and
selection/filtering logic to select one or more participants of the plurality of participants, and filter speech relating to the selected one or more participants, wherein the one or more participants are selected based on at least one of one or more of the user preferences and one or more responses to the broadcast notice.

4. The apparatus of claim 1, further comprising processing logic of the recording logic to place the recording in one or more tracks associated with one or more participants of the plurality of participants, wherein the formatted recording comprises one or more of an audio recording, a video recording, an image recording, an olfactory recording, and a haptic recording.

5. The apparatus of claim 1, wherein intelligently formatting the recording comprises shortening the recording to facilitate faster replaying of the recording to further facilitate faster transitioning of the participant into the online meeting.

6. The apparatus of claim 5, wherein shortening comprises eliminating or reducing, via silence and speed management logic of the replaying engine, a plurality of silence periods from the recording.

7. The apparatus of claim 6, wherein the plurality of silence periods are reduced by percentage or time, wherein one or more of the plurality of silence periods are further reduced, via speech pattern management logic of the replaying engine, based on a speech pattern of each of the plurality of participants.

8. The apparatus of claim 1, further comprising time and prediction logic of the replaying engine to compute an amount of synchronization time to predict an amount of transition time to perform the transitioning of the participant back into the online meeting.

9. The apparatus of claim 8, wherein the synchronization time and the transition time are communicated, via communication/compatibility logic, to the participant prior to replaying the recording.

10. The apparatus of claim 1, further comprising identification/authentication logic to identify and authenticate one or more of the requests, the plurality of participants including the participant, and a plurality of computing devices associated with the plurality of participants, wherein the plurality of computing devices comprise at least one of desktop computers and mobile computers including one or more of smartphones, tablet computers, laptops, head-mounted displays, head-mounted gaming displays, wearable glasses, wearable binoculars, smart jewelry, smartwatches, smartcards, and smart clothing items.

11. A method comprising:
receiving a request from a participant of a plurality of participants of an online meeting, wherein the request indicates disengagement of the participant from the meeting;
initiating recording of proceedings of the online meeting during absence of the participant, wherein the proceedings include conversations of remaining participants of the plurality of participants during the absence of the participant; and
intelligently formatting the recording, wherein the replaying engine is further to replay the formatted recording to the participant while transitioning the participant back into the online meeting.

12. The method of claim 11, further comprising broadcasting, in response to request, a notice to the plurality of participants, wherein the notice offers an opt-out option to allow the plurality of participants to decline participation in the recording of the proceedings.

13. The method of claim 11, further comprising:
maintaining user preferences of the plurality of participants, wherein the user preferences include instructions from the plurality of participants; and
selecting one or more participants of the plurality of participants, and filtering speech relating to the selected one or more participants, wherein the one or more participants are selected based on at least one of one or more of the user preferences and one or more responses to the broadcast notice.

14. The method of claim 11, further comprising placing the recording in one or more tracks associated with one or more participants of the plurality of participants, wherein the formatted recording comprises one or more of an audio recording, a video recording, an image recording, an olfactory recording, and a haptic recording.

15. The method of claim 11, wherein intelligently formatting the recording comprises shortening the recording to facilitate faster replaying of the recording to further facilitate faster transitioning of the participant into the online meeting.

16. The method of claim 15, wherein shortening comprises eliminating or reducing a plurality of silence periods from the recording, wherein the plurality of silence periods are reduced by percentage or time.

17. The method of claim 16, wherein one or more of the plurality of silence periods are further reduced based on a speech pattern of each of the plurality of participants.

18. The method of claim 11, further comprising computing an amount of synchronization time to predict an amount of transition time to perform the transitioning of the participant back into the online meeting.

19. The method of claim 18, wherein the synchronization time and the transition time are communicated to the participant prior to replaying the recording.

20. The method of claim 11, further comprising identifying and authenticating one or more of the requests, the plurality of participants including the participant, and a plurality of computing devices associated with the plurality of participants, wherein the plurality of computing devices comprise at least one of desktop computers and mobile computers including one or more of smartphones, tablet computers, laptops, head-mounted displays, head-mounted gaming displays, wearable glasses, wearable binoculars, smart jewelry, smartwatches, smartcards, and smart clothing items.

21. At least one machine-readable medium comprising a plurality of instructions, executed on a computing device, to facilitate the computing device to perform one or more operations comprising:
receiving a request from a participant of a plurality of participants of an online meeting, wherein the request indicates disengagement of the participant from the meeting;
initiating recording of proceedings of the online meeting during absence of the participant, wherein the proceedings include conversations of remaining participants of the plurality of participants during the absence of the participant; and
intelligently formatting the recording, wherein the replaying engine is further to replay the formatted recording to the participant while transitioning the participant back into the online meeting.

22. The machine-readable medium of claim 21, wherein the one or more operations further comprise broadcasting, in response to request, a notice to the plurality of participants, wherein the notice offers an opt-out option to allow the plurality of participants to decline participation in the recording of the proceedings.

23. The machine-readable medium of claim 21, wherein the one or more operations further comprise:
maintaining user preferences of the plurality of participants, wherein the user preferences include instructions from the plurality of participants; and
selecting one or more participants of the plurality of participants, and filtering speech relating to the selected one or more participants, wherein the one or more participants are selected based on at least one of one or more of the user preferences and one or more responses to the broadcast notice.

24. The machine-readable medium of claim 21, wherein the one or more operations further comprise placing the recording in one or more tracks associated with one or more participants of the plurality of participants, wherein the formatted recording comprises one or more of an audio recording, a video recording, an image recording, an olfactory recording, and a haptic recording.

25. The machine-readable medium of claim 21, wherein intelligently formatting the recording comprises shortening the recording to facilitate faster replaying of the recording to further facilitate faster transitioning of the participant into the online meeting.

26. The machine-readable medium of claim 25, wherein shortening comprises eliminating or reducing a plurality of silence periods from the recording, wherein the plurality of silence periods are reduced by percentage or time.

27. The machine-readable medium of claim 26, wherein one or more of the plurality of silence periods are further reduced based on a speech pattern of each of the plurality of participants.

28. The machine-readable medium of claim 21, wherein the one or more operations further comprise computing an amount of synchronization time to predict an amount of transition time to perform the transitioning of the participant back into the online meeting.

29. The machine-readable medium of claim 28, wherein the synchronization time and the transition time are communicated to the participant prior to replaying the recording.

30. The machine-readable medium of claim 21, wherein the one or more operations further comprise identifying and authenticating one or more of the requests, the plurality of participants including the participant, and a plurality of computing devices associated with the plurality of participants, wherein the plurality of computing devices comprise at least one of desktop computers and mobile computers including one or more of smartphones, tablet computers, laptops, head-mounted displays, head-mounted gaming displays, wearable glasses, wearable binoculars, smart jewelry, smartwatches, smartcards, and smart clothing items.
